(19) United States
(12) Patent Application Publication
(10) Pub. No.: US 2013/0128392 A1
(43) Pub. Date: May 23, 2013

(54) System and Method for Securely Connecting Energy Devices to a Power Bus

(71) Applicant: Chad Maglaque, Seattle, WA (US)

(72) Inventor: Chad Maglaque, Seattle, WA (US)

(21) Appl. No.: 13/300,554

(22) Filed: Nov. 19, 2011

(51) Int. Cl. H02H 7/00

(52) U.S. Cl. 361/1

(57) ABSTRACT

The invention converts the electrical circuitry in a premises for use as a power generation bus to which one or more power generating devices may be connected using a standard electrical outlet, without the need for a separate dedicated circuit or any additional electrical wiring and continuing to operate as a traditional power bus, while preventing electrical circuitry from being overloaded.

Embodiments of the power generation bus allow power generating devices to be conveniently plugged anywhere within premises, conveniently moved from location to location within premises, or conveniently moved from premises to premises as needed. Embodiments of the power generation bus dramatically reduce installation time, installation expense and inspection requirements for a power generating device, thereby lowering the fixed cost and overall payback period of a power generating device.

### CROSS REFERENCE TO RELATED APPLICATIONS

This application claims priority from the U.S. Provisional Patent Application Ser. No. 61/407,340 filed Nov. 27, 2010, the disclosure of which is attached in Appendix A hereto and incorporated herein by reference.

### BACKGROUND

Distributed power generation systems such as solar panels, wind turbines, hydro-electric generators, fuel cells, energy storage devices (such battery storage or a flywheel device for storing energy), etc. are becoming increasingly popular as a way of supplementing power to premises, and where possible, to sell excess energy back to the local power grid. These distributed generation systems, however, often require a separate dedicated electrical circuit to be added to premises in which they are used. Adding a dedicated electrical circuit is expensive and in some instances may require retrofitting existing electrical wiring, walls, some portion of the premises structure, or the addition of unsightly electrical panels and conduit. This can be particularly challenging if the existing electrical service panel is not conveniently located. At the same time, however, there often already exists several electrical circuits in premises which are used up to their maximum current carrying capacity only a small fraction of the time and which may be more accessed more conveniently than installing a dedicated electrical circuit.

### Safety Considerations

Ideally, premises owners would buy a power generation device, locate a convenient electrical outlet, plug it in, and let the device generate power as needed. Interfering with this goal, however, are safety considerations. First, any power generating device which is capable of feeding power back into the local power grid needs to stop generating power, or be isolated, if the local power grid fails or is shut down. This safety consideration takes into account the safety of line workers working on the local power grid as well as the fact that load placed on the generating device may damage any appliances or electronics devices remaining connected to the generating device through the resulting low voltage (brown-out) condition. Second, any electrical circuit with a power generating device connected to it needs to be protected from excess current. With a dedicated electrical circuit for each power generating source, the current in the circuit is limited to the generation capabilities of the device. However, if a shared electrical circuit is used, then the total current in the electrical circuit will be equal to the sum of the current generated by the power generating device plus current provided from the local power grid. Depending on the configuration of the electrical circuit and the number of devices connected to the electrical circuit, the total current may exceed the rated capabilities of the electrical circuit. If the demand of the power consuming devices on an electrical circuit is less than the rated capacity of the electrical circuit, this is not a problem as the locally produced current will be supplemented with only as much current from the local power grid as is required to meet total demand. If however, power consuming devices are added to the circuit with a total demand greater than the rated capacity of the electrical circuit, the configuration of the electrical circuit will determine if there is a point where the current produced by the power generating device and the current pulled from the local power grid exceed the capacity of the electrical circuit. If such a point exists in the circuit, then there is a danger of overheating, fire, or other mishap. It is these conditions that the power generation bus described here prevents.

### SUMMARY

In one aspect, the power generation bus includes a electrical circuit, one or more electrical connection points (such as an electrical power outlet, an electric light fixture, etc.) connected to the electrical circuit, a de-rated breaker connected to the electrical circuit and which interrupts the flow of electricity from an electrical service (such as the power grid) into the electrical circuit in the event the current flowing into the electrical circuit from the electrical service exceeds the rated capacity of the de-rated breaker, one or more secure generation disconnects operable with one or more power generating devices connected to the electrical circuit and which disable one or more power generating devices or interrupt the flow of electricity from one or more power generating devices into the electrical circuit whether manually or electronically or in the event the current flowing from one or more generating devices exceeds the rated capacity of the secure generation disconnect.

Additionally, the de-rated breaker may monitor the status of the commercial power grid, if the premises are connected to one, and may provide external communication interfaces for monitoring and controlling the power generation bus either directly or remotely by the premises owner or a third party (such as a local utility or service provider).

In yet an additional aspect, a method of retrofitting an existing electrical circuit for use as an power generation bus (including a plurality of power generating devices connected to a common electrical circuit) may include replacing an existing electrical outlet with a de-rated breaker that fits inside an existing electrical outlet box.

In yet a further aspect, a method of retrofitting an existing electrical circuit for use as an power generation bus (including a plurality of power generating devices connected to a common electrical circuit) may include replacing an existing electrical outlet with a dual-mode breaker that fits inside an existing electrical outlet box and is capable of switching between a de-rated mode and fully rated mode.

In yet one more aspect, a method of retrofitting an existing electrical circuit for use as an power generation bus (including a plurality of power generating devices connected to a common electrical circuit) may include replacing an existing circuit breaker with a de-rated breaker that fits inside an existing circuit breaker slot.

In yet one further aspect, a method of retrofitting an existing electrical circuit for use as an power generation bus (including a plurality of power generating devices connected to a common electrical circuit) may include replacing an existing circuit breaker with a dual-mode breaker that fits inside an existing circuit breaker slot and is capable of switching between a de-rated mode and fully rated mode.

In some implementations, multiple communicatively linked computing devices may be used as part of an power generation bus. One or more of these computing devices may be communicatively linked in any suitable way such as via one or more networks. One or more networks can include: the Internet, one or more local area networks (LANs), one or more wide area networks (WANs). Network communication may include: wired technologies such as Ethernet, twisted pair, coaxial cable, optical fiber, power line communication (PLC) or wireless technologies such as Wi-Fi/IEEE 802.11x, Bluetooth, Zigbee, WiMAX, General Packet Radio Service (GPRS), EDGE, CDMA, GSM, Near Field Communication (NFC), Radio Frequency Identification (RFID), microwave, infrared or any combination thereof. Additionally, information may be transmitted as a single stream or multiplexed to combine multiple analog message signals or digital data streams into a single signal. And in the event that power line communication is used, the power generation bus may further include one or more power line filters to remove any extraneous signals from the power generations bus as needed.

The foregoing summary is illustrative only and is not intended to be in any way limiting. In addition to the illustrative aspects, embodiments, and features described above, further aspects, embodiments, and features will become apparent by reference to the drawings and the following detailed description.

### DESCRIPTION OF THE FIGURES

Various embodiments of the present invention are described herein by way of example in conjunction with the following figures, wherein:

FIG. 1 is a schematic of a typical electrical circuit

FIG. 2 is a schematic of a power generation bus with a de-rated breaker and a secure generation disconnect according to various embodiments;

FIG. 3 is a schematic of a de-rated breaker according to various embodiments;

FIG. 4 is a schematic of a secure generation disconnect according to various embodiments;

FIG. 5 is a schematic of a power generation bus with a de-rated breaker located between an electrical panel and an electrical outlet according to various embodiments;

FIG. 6 is a schematic of a power generation bus with a plurality of secure generation disconnects connected individually to an electrical connection point;

FIG. 7 is a schematic of a power generation bus with a plurality of secure generation disconnects connected to an electrical connection point;

FIG. 8 is a schematic of a power generation bus with a plurality of power generation devices connected to a secure generation disconnect;

FIG. 9 is a schematic of a power generation bus with a power storage device connected to a secure generation disconnect;

FIG. 10 is a schematic of a power generation bus with a power generation device and a secure generation disconnect located in the same device;

FIG. 11 is a schematic of two power generation buses;

FIG. 12 is a schematic of a conventional electrical circuit before retrofitting an existing circuit breaker according to various embodiments;

FIG. 13 is a schematic of a conventional electrical circuit after retrofitting an existing circuit breaker according to various embodiments;

FIG. 14 is a schematic of a conventional electrical circuit before retrofitting an existing electrical outlet according to various embodiments;

FIG. 15 is a schematic of a conventional electrical circuit after retrofitting an existing electrical outlet according to various embodiments;

FIG. 16 is a schematic of a power generation bus with multiple communicatively linked computing devices;

FIG. 17 is a schematic of a network-enabled de-rated breaker according to various embodiments;

FIG. 18 is a schematic of a network-enabled secure generation disconnect according to various embodiments;

FIG. 19 is a listing of an operational certificate;

FIG. 20 is a schematic of a dual-mode breaker according to various embodiments;

FIG. 21 is a schematic of a dual-mode breaker used in conjunction with an existing circuit breaker;

FIG. 22 illustrates a computing device according to various embodiments;

FIGS. 23-28 illustrate secure keys according to various embodiments;

### DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The term “power generating device” as used herein, includes without limitation any device (such as a wind turbine, solar panel, hydro-electric generator, battery storage, flywheel or fuel cell) that is able to convert kinetic or potential energy (such as chemical, gravitational, mechanical, nuclear, thermal, optical, EMF, kinematic and sound energy) into electrical energy.

The term “power consuming device” as used herein, includes without limitation any device (such as a motor, light bulb, heater, radio or battery charger, etc.) that uses electrical energy to operate or is able to convert electrical energy into kinetic or potential energy.

The term “daisy chain” as used herein, is a wiring scheme in which, for example, device A is wired to device B, device B is wired to device C, device C is wired to device D, etc. Connections do not form webs (in the preceding example, device C cannot be directly connected to device A), nor do they loop back from the last device to the first.

The term “commercial power feed” as used herein, refers to the primary source of electrical power for the premises. Typically the primary source of a premises' power is from the local electric power grid; however, this is not a requirement for the operation of a power generation bus. Premises may operate completely autonomously (also known as “off-grid”) using solar, wind, hydroelectric energy or any other power source, without any reliance on an electrical power grid.

The term “premises” as used herein, includes without limitation any permanent or temporary, stationary or mobile structure used or intended for supporting or sheltering any use or occupancy, and may include without limitation residential homes, commercial buildings, temporary shelters, vehicles, watercraft, aircraft, spacecraft, etc.

The term “electrical circuit” as used herein, refers to a closed loop with one or more component nodes and a return path for electric current to flow to which a number of electrical laws apply, including Kirchoff's Current Law (that is, the sum of all currents entering a node is equal to the sum of all currents leaving the node), Kirchoff's Voltage Law (that is, the directed sum of the electrical potential differences around a loop must be zero) and Ohm's Law (that is, at a constant temperature, the voltage across a resistor is equal to the product of the resistance and the current through it) and through which current may flow in one direction (DC) or may alternate directions (AC) at a given frequency (e.g. 60 Hz AC or 50 Hz AC).

The term “electromagnetic induction” as used herein, refers to the production of voltage across a conductor situated in a changing magnetic field or a conductor moving through a stationary magnetic field.

The term “secure key” as used herein, includes without limitation any device that prevents unauthorized operation of one or more generating devices, and when operable with a secure generation disconnect (either directly or remotely across a communications network) enables one or more power generating devices to generate power and/or allows the flow of electricity from one or more power generating devices into an electrical circuit. And when in inoperable with a secure generation disconnect (such as when the secure key is removed from the secure generation disconnect or no longer accessible via a communications network) disables one or more power generating devices to generate or interrupts the flow of electricity from one or more power generating devices into an electrical circuit. A secure key includes without limitation a physical key used to operate an electrical switch or actuator, a conductive, resistive, fusible, electronic, electro-mechanical or electro-magnetic key used to close or open a circuit, an electronic proximity key, a digital key or operational certificate that can be exchanged between two devices either physically (for example stored on a storage device or electronic chip) or electronically across a communications network, etc. See FIGS. 23-28 for examples of secure keys.

The term “secure key authority” as used herein, includes without limitation any device or entity such as energy service provider, a regulatory or permitting authority, a third party service provider, a system installer or electrical contractor, a device manufacturer, etc. that is authorized by a manufacturer of the present invention to issue secure keys for use in the present invention.

The term “unauthorized operation” as used herein, includes without limitation any use or operation of the present invention that is not authorized by a regulatory or permitting authority, energy service provider, third party service provider or manufacturer of the present invention.

In general, terms used herein should be read to have their ordinary and common meanings as understood by one of ordinary skill in the art in view of the descriptions provided herein.

A variety of power generation bus configurations are described herein. In some embodiments, these configurations may be well-adapted to be installed in homes. In other embodiments, these configurations may be appropriate for use in small, medium or large commercial buildings, temporary shelters, vehicles, etc. In some embodiments, the power generating bus may be an existing electrical circuit, a new electrical circuit, or an electrical cable connection.

### General Operation

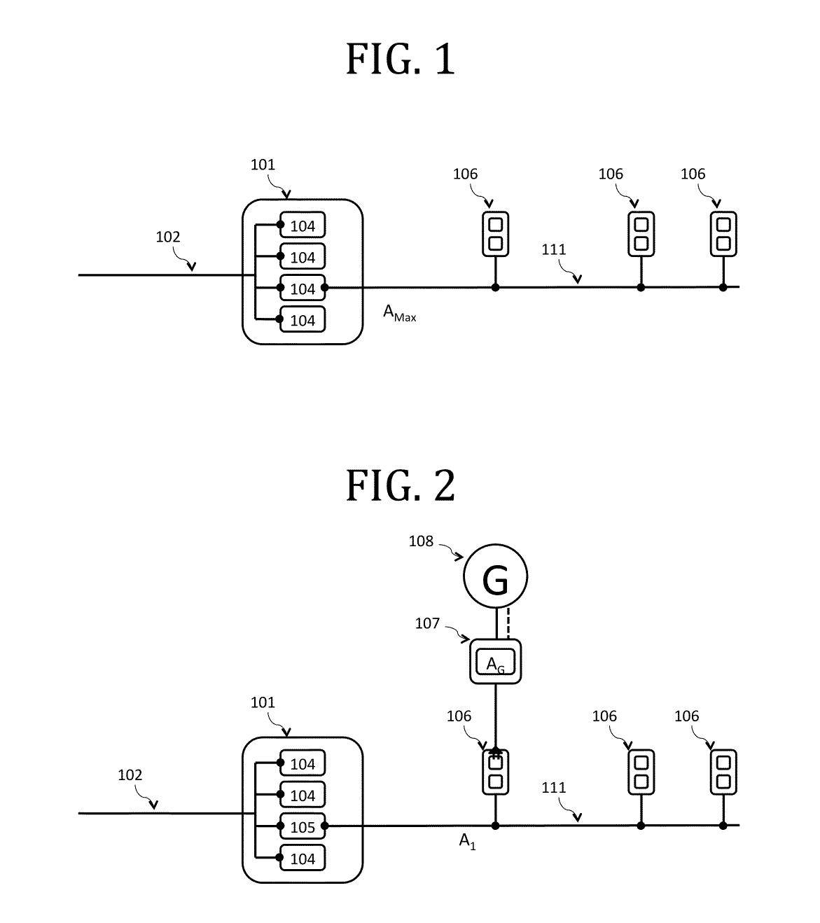

FIG. 1 is a schematic of a typical electrical circuit found in a premise. A commercial power feed 102 from the local power grid is connected to an electric service panel 101 inside of which are connected one or more electrical circuits 111 (only one complete electrical circuit is shown for simplicity). Electrical circuit 111 is connected to the electric service panel 101 via a circuit breaker 104 which interrupts the flow of electricity within the electrical circuit in the event the total current flowing through the electrical circuit 111 exceeds the rated capacity Aₘₐₓ of the electrical circuit 111. Connected to electrical circuit 111 are one or more electrical connection points 106 (such as an electrical power outlet, an electric light fixture, junction box, etc.).

FIG. 2 is a schematic of one embodiment of a power generation bus with one or more power generating devices connected individually to an electrical outlet. A commercial power feed 102 from the local power grid is connected to an electric service panel 101 inside of which are connected one or more electrical circuits 111 (only one complete electrical circuit is shown for simplicity). Electrical circuit 111 is connected to the electric service panel 101 through a de-rated breaker 105 which limits the current A_{D} flowing into electrical circuit 111 from the electric service panel 101 and is rated less than the original circuit breaker 104 such that the sum of the amperage of all subsequent power sources connected to the power bus will not exceed the electrical rating of the power bus. Connected to electrical circuit 111 are one or more electrical connection points 106.

Placed at a point between electrical connection 106 and power generating device 108 is secure generation disconnect 107 which disables one or more power generating devices 108 or interrupts the flow of electricity from one or more power generating devices 108 into the electrical circuit whether manually or electronically or in the event the current flowing from one or more generating devices exceeds the rated capacity A_{G} of the secure generation disconnect.

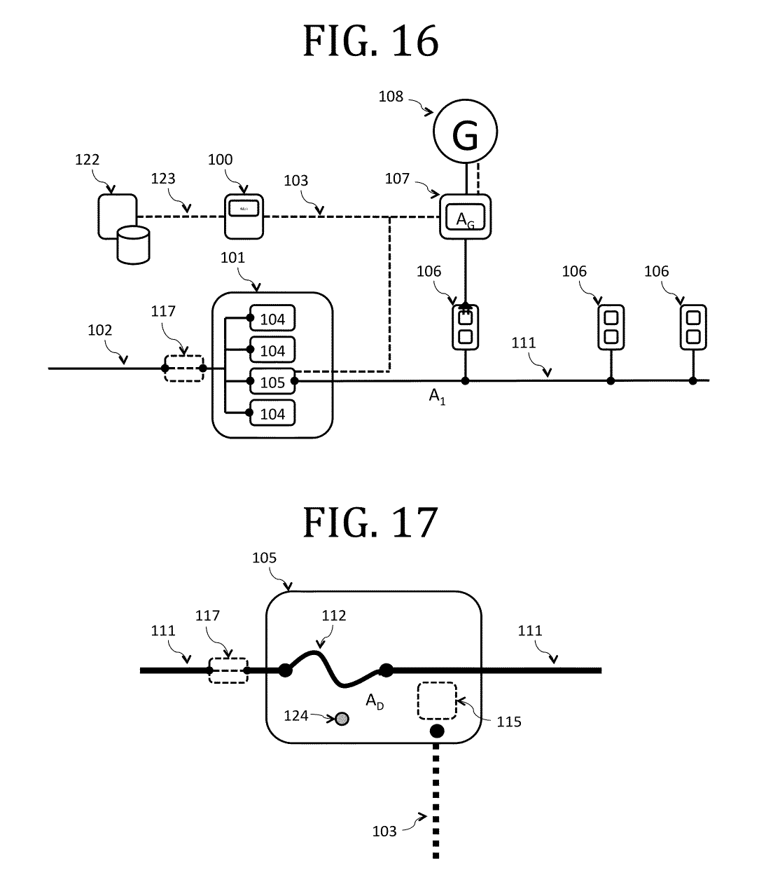

In FIG. 2 and other embodiments described herein, secure generation disconnect 107 may be fully operable with power generating device 108 allowing it to enable or disable power generating device 108 or transmit operating parameters (such as output voltage, output amps, output power, stored energy, device status, device properties, device temperature, wind speed, wind direction, ambient temperature, ambient pressure, ambient humidity, etc.) to a central monitor console 100 or management console 122 via communications network 103 (shown in FIG. 16), or both.

In the event that the current A_{D} flowing through de-rated breaker 105 plus the generating current A_{G} generated by power generation device 108 together exceed the current rating of electrical circuit 111 (that is, A_{D}+A_{G}>Aₘₐₓ) de-rated breaker 105 will trip, interrupting the flow of electricity into electrical circuit 111 thus preventing a circuit overload condition. To avoid repeated or unnecessary tripping of de-rated breaker 105, de-rated breaker 105 should be sized to permit reasonable operation of power consuming devices connected to electrical circuit and the number of power generation devices 108 that can be enabled for a given de-rated breaker 105 should be reasonably limited.

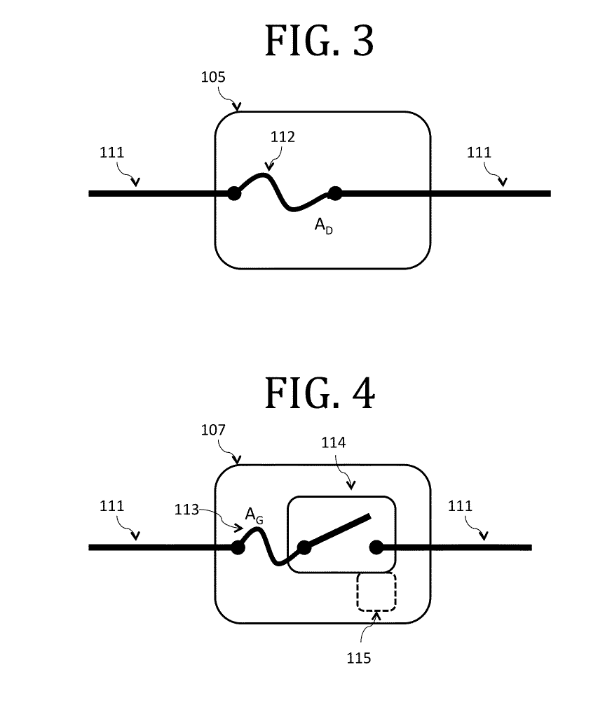

FIG. 3 is a schematic of one embodiment of a de-rated breaker 105 including an overcurrent device 112 that limits the current flowing into the electrical circuit 111 to the amount A_{D}.

FIG. 4 is a schematic of one embodiment of a secure generation disconnect 107 including an overcurrent device 113 that limits the total current flowing from one or more power generating devices connected to secure generation disconnect 107 to A_{G}. Depending on the embodiment, switch 114 may be either a physical or electronic disconnect that is actuated when a secure key 115 logically associated with de-rated breaker 105 (for example, using a unique identifier such as a serial number) is physically or electronically proximate of secure generation disconnect 107, and disconnected when secure key 115 is not physically or electronically proximate of secure generation disconnect 107. In this manner, any power generating devices 108 connected to secure generation disconnect 107 can only operate when a secure key 115 supplied by a secure key authority is physically or electronically proximate of secure generation disconnect 107, thus preventing unauthorized or disabled power generating devices 108 from supplying power to electrical circuit 111. Note, it is the responsibility of the secure key authority, for example, the manufacturer of de-rated breaker 105, to supply or authorize only enough secure keys 115 logically associated with de-rated breaker 105 to match the combined amperage rating of de-rated breaker 105 and one or more secure generation disconnects 107 such that the rating of electrical circuit 111 is not exceeded. Typically, the rating of electrical circuit 111 is well known and established by permitting authorities and regional or national electrical codes.

### Different Configurations

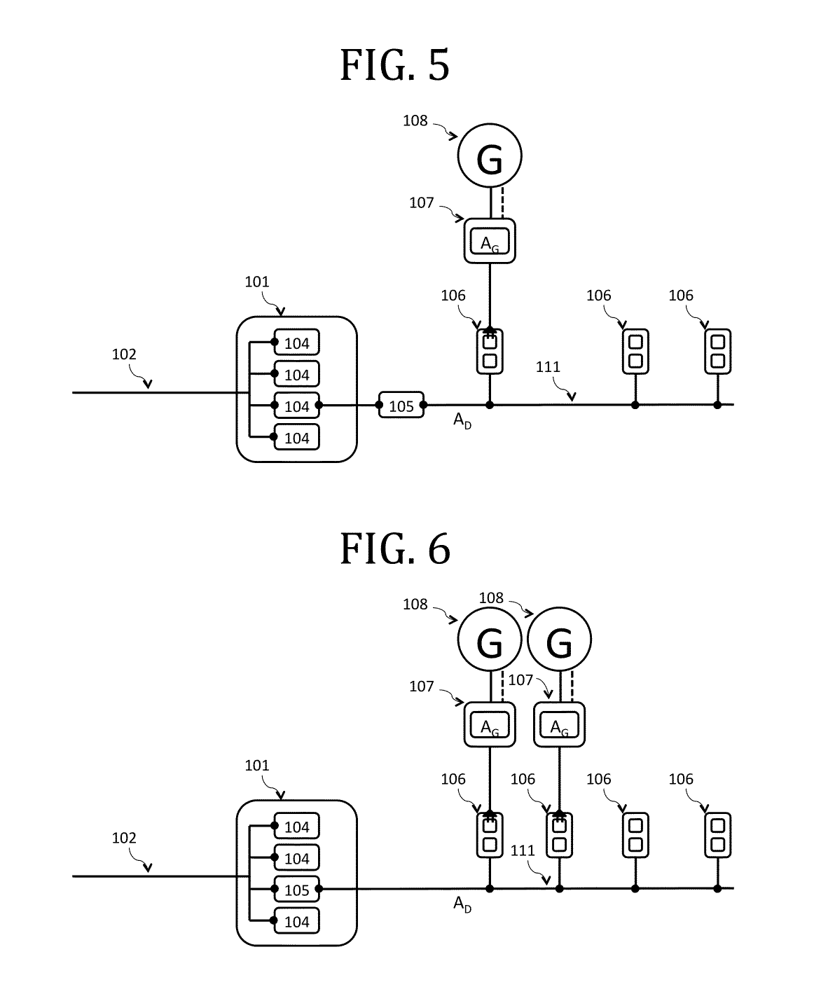

FIG. 5 is a schematic of one embodiment of a power generation bus with one or more power generating devices connected individually to an electrical outlet. A commercial power feed 102 from the local power grid is connected to an electric service panel 101 inside of which are connected one or more electrical circuits 111 (only one complete electrical circuit is shown for simplicity). Electrical circuit 111 is connected to the electric service panel 101 through a circuit breaker 104. Connected to electrical circuit 111 are one or more electrical connection points 106. Placed at any point between circuit breaker 104 and up to and including the first connection point 106 is de-rated breaker 105 which limits the current A₁ flowing into electrical circuit 111 from the electric service panel 101. Placed at a point between one or more electrical connections 106 and one or more power generating devices 108 is secure generation disconnect 107 which disables one or more power generating devices or interrupts the flow of electricity from one or more power generating devices 108 into electrical circuit 111 whether manually or electronically or in the event the current flowing from one or more generating devices exceeds the rated capacity A_{G} of the secure generation disconnect 107.

FIG. 6 is a schematic of one embodiment of a power generation bus with a plurality of power generating devices connected individually to an electrical outlet. A commercial power feed 102 from the local power grid is connected to an electric service panel 101 inside of which are connected one or more electrical circuits 111 (only one complete electrical circuit is shown for simplicity). Electrical circuit 111 is connected to the electric service panel 101 through a de-rated breaker 105 which limits the current A_{D} flowing into the electrical circuit 111 from the electric service panel 101. Connected to electrical circuit 111 are one or more electrical connection points 106. Placed at points between one or more electrical connections 106 and one or more power generating devices 108 are secure generation disconnects 107 which disable one or more power generating devices 108 or interrupts the flow of electricity from one or more power generating devices 108 into electrical circuit 111 whether manually or electronically or in the event the current flowing from one or more generating devices 108 exceeds the rated capacity A_{G1}, A_{G2} . . . A_{Gn} of the respective secure generation disconnects 107.

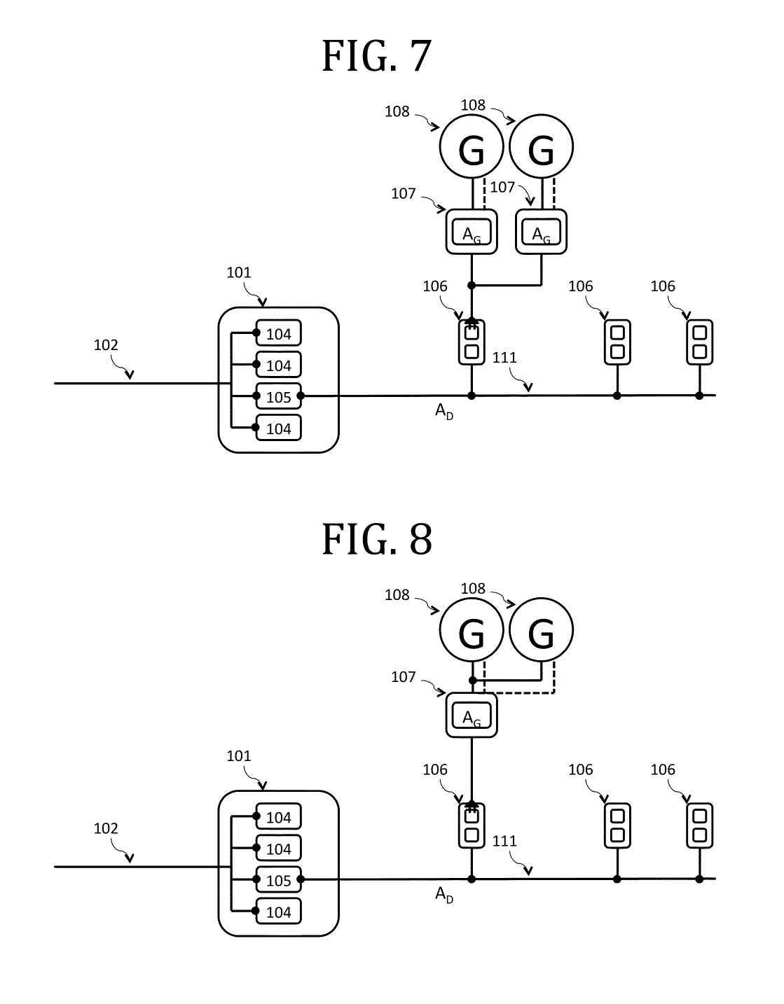

FIG. 7 is a schematic of one embodiment of a power generation bus with a plurality of secure generation disconnects connected to the same electrical outlet. A commercial power feed 102 from the local power grid is connected to an electric service panel 101 inside of which are connected one or more electrical circuits 111 (only one complete electrical circuit is shown for simplicity). Electrical circuit 111 is connected to the electric service panel 101 through a de-rated breaker 105 which limits the current A_{D} flowing into the electrical circuit 111 from the electric service panel 101. Connected to electrical circuit 111 are one or more electrical connection points 106. Placed at points between one or more electrical connections 106 and a plurality of power generating devices 108 are secure generation disconnects 107 which disable one or more power generating devices 108 or interrupt the flow of electricity from one or more power generating devices 108 into electrical circuit 111 whether manually or electronically or in the event the current flowing from one or more generating devices 108 exceeds the rated capacity A_{G1}, A_{G2} . . . A_{Gn} of the respective secure generation disconnects 107.

FIG. 8 is a schematic of one embodiment of a power generation bus with a plurality of power generation devices in a daisy chain or aggregated through a single secure generation disconnect. A commercial power feed 102 from the local power grid is connected to an electric service panel 101 inside of which are connected one or more electrical circuits 111 (only one complete electrical circuit is shown for simplicity). Electrical circuit 111 is connected service panel 101 through a de-rated breaker 105 which limits the current A_{D} flowing into the electrical circuit to the electric 111 from the electric service panel 101. Connected to electrical circuit 111 are one or more electrical connection points 106. Placed at a point between one or more electrical connections 106 and a plurality of power generating devices 108 is secure generation disconnect 107 which disables one or more power generating devices 108 or interrupts the flow of electricity from one or more power generating devices 108 into electrical circuit 111 whether manually or electronically or in the event the current flowing from one or more generating devices 108 exceeds the rated capacity A_{G} of secure generation disconnect 107.

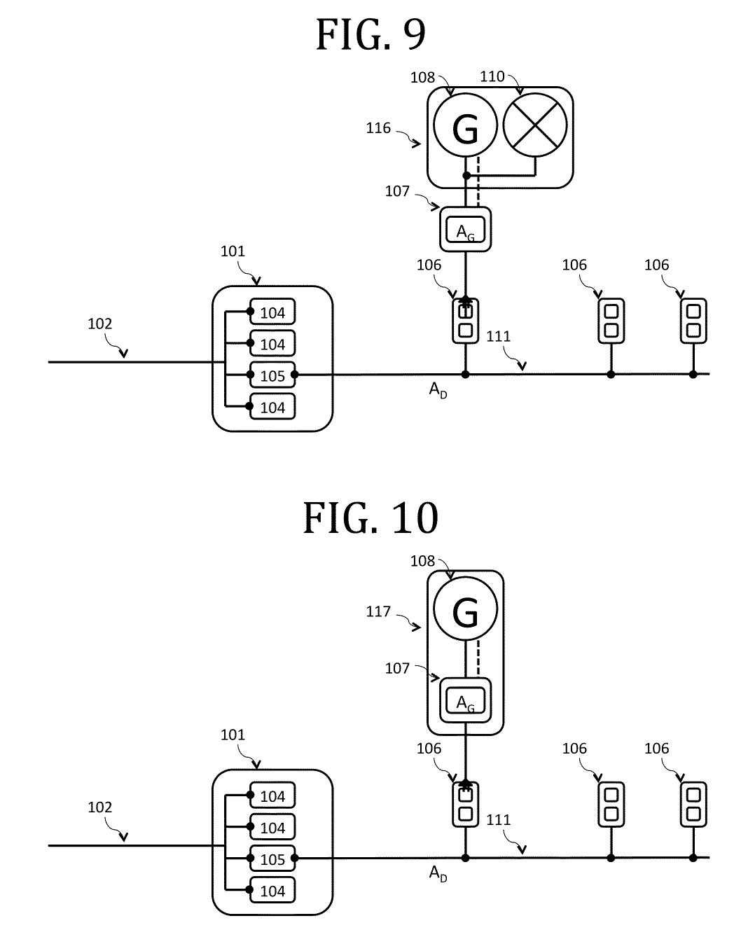

FIG. 9 is a schematic of one embodiment of a power generation bus with a power generation device 108 and a power consumption device 110 both combined into the same bi-directional energy flow device 116 (such battery storage or a flywheel device for storing energy). The components and operation of the power generation bus assembly are the same as described in the previous embodiments, the only difference being that both power generation and consumption are combined into the same bi-directional energy flow device 116 and is managed by secure generation disconnect 107.

FIG. 10 is a schematic of one embodiment of a power generation bus with both the secure generation disconnect 107 and power generation device 108 co-located in the same device 117. The components and operation of the power generation bus assembly are the same as described in the previous embodiments.

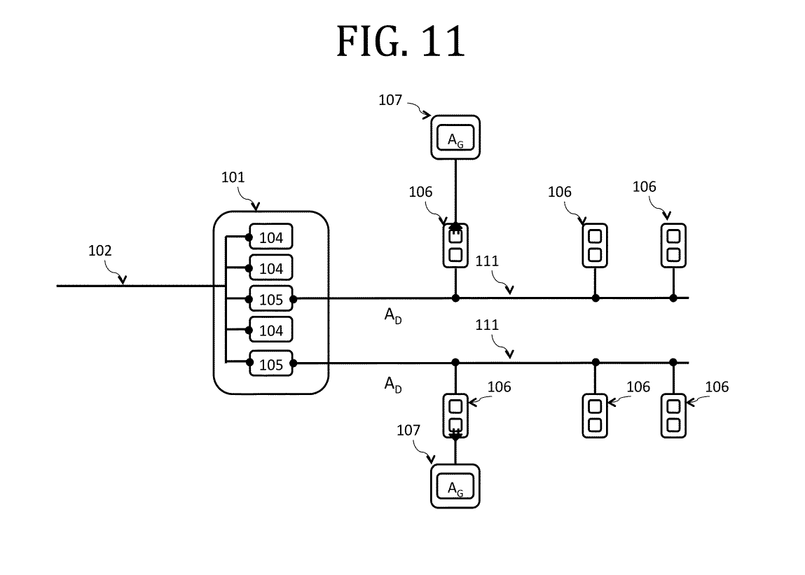

FIG. 11 is a schematic of one embodiment of two power generation buses. The components and operation of the power generation bus assemblies are the same as described in the previous embodiments, each contain a de-rated breaker 105 and one or more secure generation disconnects 107 operable with one or more power generating devices (not shown for simplicity).

### Retrofitting an Existing Electrical Circuit

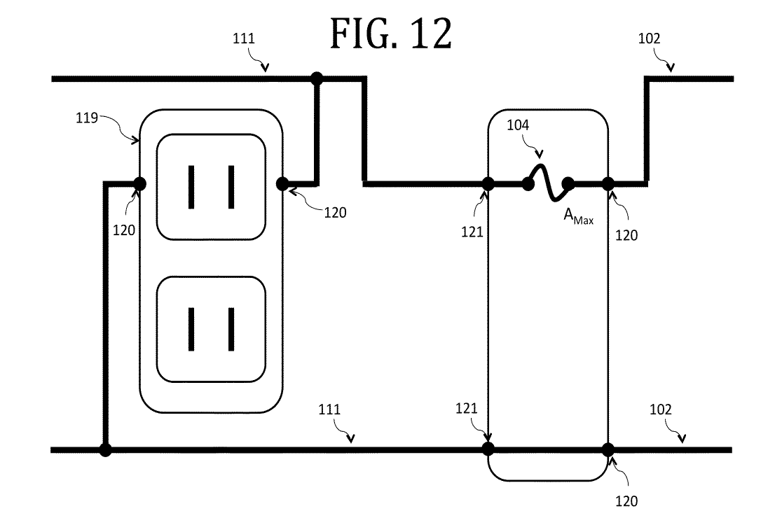

FIG. 12 is a schematic of a one embodiment of a conventional electrical circuit before being retrofitted for use as a power generation bus. Before retrofitting, one or more conventional electrical plugs 119 are connected in parallel to electrical circuit 111 via line terminals 120 and electrical circuit 111 is connected to circuit breaker 104 at load terminals 121 and commercial power feed 102 is connected to circuit breaker 104 at line terminals 120 inside a conventional electrical panel (electrical panel not shown for simplicity), physically interrupting electrical circuit 111 from commercial power feed 102. In the illustrated embodiment, one or more conventional electrical plugs 119 are connected in parallel to the remaining portion of electrical circuit 111 via line terminals 120

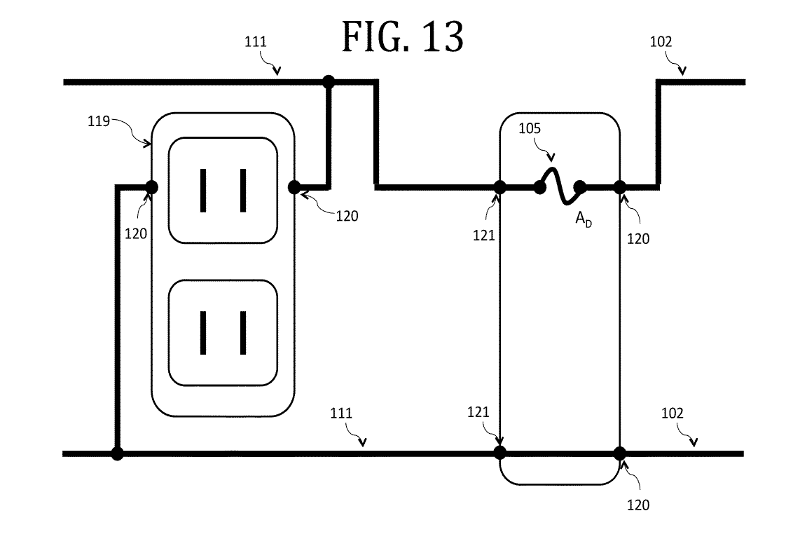

FIG. 13 is a schematic is one embodiment of a conventional electrical circuit after retrofit for use as a power generation bus. To retrofit the electrical circuit, electrical circuit 111 is connected to a de-rated circuit breaker 105 at load terminals 121 and commercial power feed 102 is connected to circuit breaker 105 at line terminals 120 inside a conventional electrical panel (not shown for simplicity), physically interrupting electrical circuit 111 from commercial power feed 102. In the illustrated embodiment, one or more conventional electrical plugs 119 remain connected in parallel to the remaining portion of electrical circuit 111 via line terminals 120.

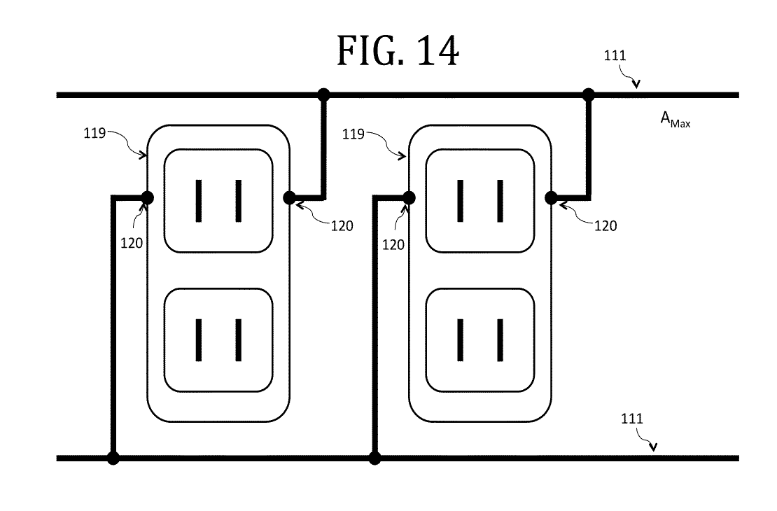

FIG. 14 is a schematic of a one embodiment of a conventional electrical circuit before being retrofitted for use as a power generation bus. Before retrofitting, one or more conventional electrical plugs 119 are connected in parallel to electrical circuit 111 via line terminals 120 and fit inside an existing electrical outlet box.

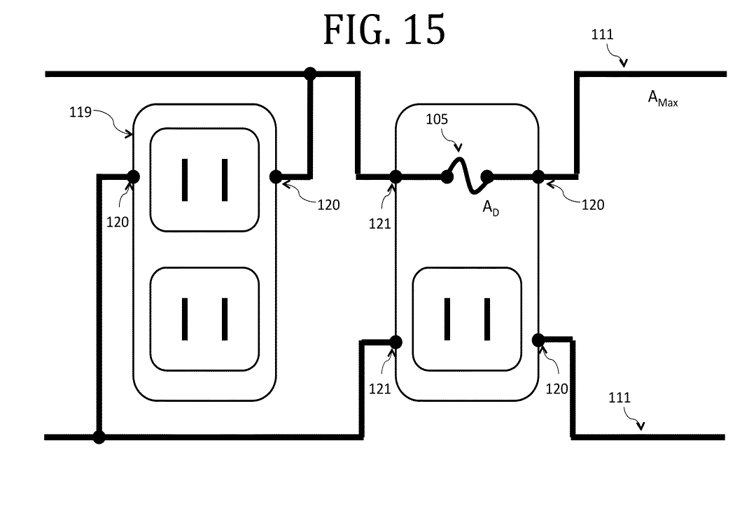

FIG. 15 is a schematic of a one embodiment of a conventional electrical circuit after retrofit for use as a power generation bus. To retrofit the electrical circuit, electrical circuit 111 is connected to de-rated breaker 105 at line terminals 120, physically interrupting electrical circuit 111. In the illustrated embodiment, the remaining portion of electrical circuit 111 is then connected to de-rated breaker 105 at load terminals 121, with one or more conventional electrical plugs 119 then connected in parallel to electrical circuit 111 via line terminals 120. In some embodiments, de-rated breaker 105 may fit inside an existing electrical outlet or newly installed electrical junction box.

The Figures depict several different electrical wiring configurations. Some embodiments may include a circuit isolation switch at any point after the commercial power feed enters the premises which can be used to electrically isolate the premises' electrical wiring, a portion of the premises' electrical wiring or a limited number of circuits from the commercial power grid in the event of failure of the commercial power grid or other event.

### Network-Enabled Power Bus

FIG. 16 is a schematic of a one embodiment of a power generation bus with multiple communicatively linked devices. One or more of these devices (for example, secure generation disconnect 107, de-rated breaker 105, monitoring console 100 and management console 122) may be communicatively linked in any suitable way such as via one or more communication networks 103 and 123. One or more networks can include: the Internet, one or more local area networks (LANs), one or more wide area networks (WANs). Network communication may include: wired technologies such as Ethernet, twisted pair, coaxial cable, optical fiber, power line communication (PLC) or wireless technologies such as Wi-Fi/IEEE 802.11x, Bluetooth, Zigbee, WiMAX, General Packet Radio Service (GPRS), EDGE, CDMA, GSM, Near Field Communication (NFC), Radio Frequency Identification (RFID), microwave, infrared or any combination thereof. Additionally, information may be transmitted as a single stream or multiplexed to combine multiple analog message signals or digital data streams into a single signal. And in the event that power line communication is used, the power generation bus may further include one or more power line filters 117 to remove any extraneous signals from the power generations bus as needed.

In FIG. 16 and described elsewhere herein the communication networks 103 and 123 are illustrated as physically separate from an electrical circuit 111 and commercial power feed 102. Depending on the embodiment, the electrical circuit 111 and commercial power feed 102 may be used for communication.

In one embodiment, one or more de-rated breakers 105, one or more secure generation disconnects 107 and/or one or more power generating devices 108 may provide external interfaces for monitoring, logging data, configuring, maintaining and controlling the power generation bus and any connected power generating devices 108 either directly to a monitoring console 100 via a communication network 103 or remotely by the premises owner or a third party (such as a local utility or service provider) to a management console 122 via a communication network 123.

In addition, monitoring console 100 and/or management console 122 may monitor the status of the commercial power feed 102 by way of de-rated breaker 105, if the premises are connected to one, and may provide other maintenance functions such as software or firmware updates for de-rated breakers 105, secure generation disconnects 107 and power generation devices 108.

Further, in order to configure and/or optimize various operational parameters, the user or a third party may connect a computer or other processor-based device to the power generation bus via either communication network 123 or communication network 103 and subsequently upload and/or upgrade control parameters of either the de-rated breaker 105 or the management console 122, or both.

FIG. 17 is a schematic of one embodiment of a network enabled de-rated breaker 105 including an overcurrent device 112 that limits the current flowing into the electrical circuit 111 to the amount A_{D} and is communicatively linked to one or more secure generation disconnects 107 (not shown for simplicity) via communications network 103. Additionally, one or more secure keys 115 are operable with de-rated breaker 105 and where each secure key 115 is logically associated with a secure generation disconnect 107 (for example using a unique identifier). In one embodiment, switch 114 located on secure generation disconnect 107 is actuated when a secure key 115 is physically or electronically proximate of de-rated breaker 105, and disconnected when secure key 115 is not physically or electronically proximate of de-rated breaker 105. In this manner, any power generating devices 108 connected to secure generation disconnects 107 can only operate when a secure key 115 supplied by a secure key authority is physically or electronically proximate of de-rated breaker 105, thus preventing unauthorized or disabled power generating devices 108 from supplying power to electrical circuit 111. Again, it is the responsibility of the secure key authority, for example, the manufacturer of de-rated breaker 105, to limit the number of secure keys 115 that may be physically or electronically proximate of de-rated breaker 105 (such as limiting the number of secure key slots) or supply or authorize only enough secure keys 115 associated with de-rated breaker 105 or in order to match the combined amperage rating of de-rated breaker 105 and one or more secure generation disconnects 107 such that the rating of electrical circuit 111 is not exceeded.

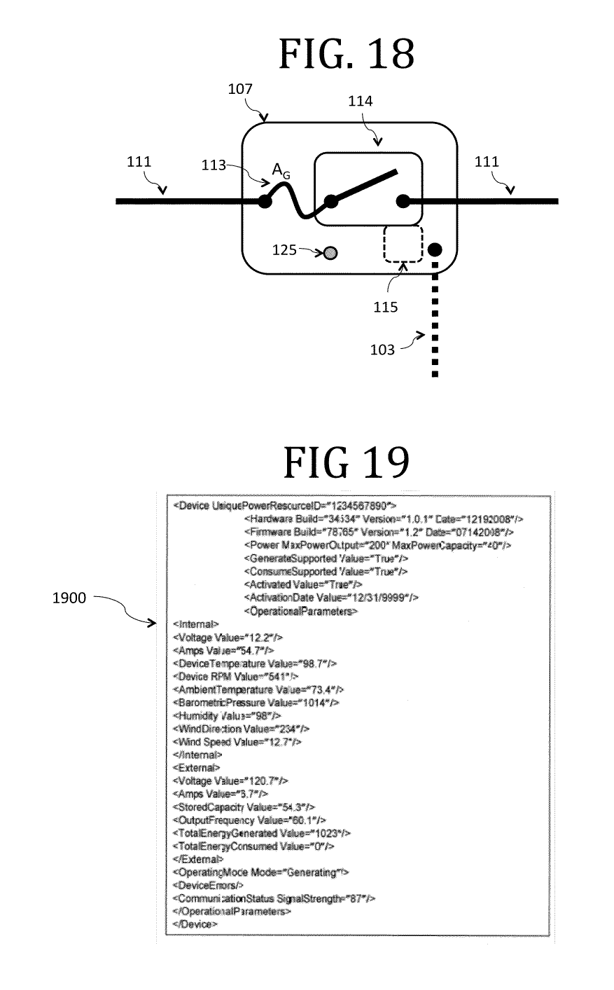

FIG. 18 is a schematic of one embodiment of a network enabled secure generation disconnect 107 including an overcurrent device 113 that limits the total current flowing from one or more power generating devices connected to secure generation disconnect 107 to A_{G} and is communicatively linked to de-rated breaker 105 (not shown for simplicity) via communications network 103.

In one embodiment, pressing synchronizing button 124 on de-rated breaker 105 while simultaneously pressing a similar synchronizing button 125 on secure generation disconnect 107 opens a synchronization channel between the two devices via communications network 103, exchanges the device properties of secure generation disconnect 107 (such as a unique resource identifier, serial number, network address or location, hardware build, hardware version, hardware date, firmware version, firmware date, firmware build, etc.) and the operation parameters of any power generating devices 108 operable with secure generation disconnect 107. Depending on the rating of de-rerated breaker 105, the rating of secure generation disconnect 107 and any previously enabled secure generation disconnects, de-rated breaker 105 may issue a secure key, which may or may not include an operational certificate (shown in FIG. 19) controlling the operation and output of any power generating devices 108 operable with secure generation disconnect 107, and which the secure generation disconnect 107 in turn may record and save in non-volatile memory. Depending on the embodiment, switch 114 operable with secure generation disconnect 107 may be either a physical or electronic disconnect that is actuated when a secure key 115 is present in the non-volatile memory of secure generation disconnect 107, and disconnected when secure key 115 is not present in the non-volatile memory of secure generation disconnect 107. In this manner, any power generating devices 108 connected to secure generation disconnects 107 can only operate when a secure key 115 supplied by a secure key authority (in this case de-rated circuit breaker 105) is present in the non-volatile memory of secure generation disconnect 107, thus preventing unauthorized or disabled power generating devices 108 from supplying power to electrical circuit 111.

In a further embodiment, pressing synchronizing button 124 on de-rated breaker 105 while simultaneously pressing a similar synchronizing button 125 on secure generation disconnect 107 opens a synchronization channel between the two devices via communications network 103, exchanging the device properties of secure generation disconnect 107 (such as a unique resource identifier, serial number, network address or location, hardware build, hardware version, hardware date, firmware version, firmware date, firmware build, etc.) and the operation parameters of any power generating devices 108 operable with secure generation disconnect 107. Depending on the rating of de-rerated breaker 105, the rating of secure generation disconnect 107 and any previously enabled secure generation disconnects, de-rated breaker 105 may store a secure key logically associated with secure generation disconnect 107 (for example using a unique identifier) in non-volatile memory, and which may or may not include an operational certificate (shown in FIG. 19) controlling the operation and output of any power generating devices 108 operable with secure generation disconnect 107. Depending on the embodiment, switch 114 operable with secure generation disconnect 107 may be either a physical or electronic disconnect that is actuated when a secure key 115 is present in the non-volatile memory of de-rated breaker 105, and disconnected when secure key 115 is not present in the non-volatile memory of de-rated breaker 105. In this manner, any power generating devices 108 connected to secure generation disconnects 107 can only operate when a secure key 115 supplied by a secure key authority (in this case de-rated circuit breaker 105) is present in the non-volatile memory of de-rated breaker 105, thus preventing unauthorized or disabled power generating devices 108 from supplying power to electrical circuit 111.

In yet another embodiment, the de-rated breaker 105 may monitor communications network 103 to detect the presence of a previously unauthorized secure generation disconnect 107. The secure generation disconnect 107 may then be automatically authorized to work with the de-rated breaker 105 by exchanging a secure key and any operational certificate and then storing this in non-volatile memory as described herein. If the secure generation disconnect 107 is later to be used with another de-rated breaker 105 or power generation bus, the secure key and operational certificate stored in non-volatile memory can then be cleared through the use of a reset switch or mechanism.

FIG. 19 illustrates an operational certificate of operational parameters controlling the operation and output of a power generating device. As shown, the listing 1900 may be in an XML format.

Use with Variable Rating Breakers

In still another embodiment, the de-rated breaker 105 may be a variable rating breaker that can be set to trip at different current flows and when a secure key 115 is issued to enable a secure generation disconnect 107 the rating A_{D} of de-rated breaker 105 may be lowered by the offsetting rating A_{G} of the secure generation disconnect 107, thus ensuring that the sum of the amperage of all power sources connected to the power bus does not exceed the electrical rating A_{Max} of the power generation bus. Similarly, when a secure key 115 physically or electronically proximate with de-rated breaker 105 is relocated to be physically or electronically proximate with secure generation disconnect 107, the rating A_{D} of de-rated breaker 105 may be lowered by the offsetting amount of rating A_{G} of the secure generation disconnect 107, again ensuring that the sum of the amperage of all power sources connected to the power bus does not exceed the electrical rating Aₘₐₓ of the power generation bus. Further, the rating A_{D} of de-rated breaker 105 may be increased by the amount of rating A_{G} of the secure generation disconnect 107 when a secure key 115 is revoked or secure key 105 is physically or electronically proximate with secure generation disconnect 107 is relocated to be physically or electronically proximate with de-rated breaker 105

### Remote Authorization

It will be appreciated by one of ordinary skill in the art that in each the embodiments described above secure keys may be authorized and transmitted by a remote secure key authorization service either communicatively linked to de-rated breaker 105 and/or secure generation disconnect 107 via communications networks 103 and 123, or may be authorized by a remote secure key authorization service and transferred to de-rated breaker 105 and/or secure generation disconnect 107 via a digital storage medium.

### Dual-mode Circuit Breaker

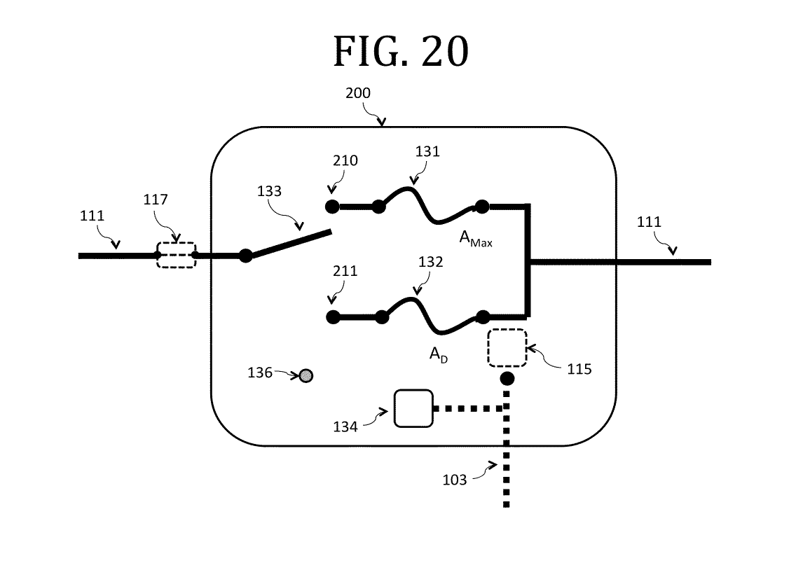

FIG. 20 is a schematic of one embodiment of a dual-mode circuit breaker 200 that fits inside an existing circuit breaker slot and includes an overcurrent device 131 that limits the current flowing into an electrical circuit 111 to electrical circuit's 111 the rated amount A_{Max}, an overcurrent device 132 that limits the current flowing into the electrical circuit 111 to the de-rated amount A_{D}, a switch 133 which may be either physical or electronic and can be actuated either manually (for example, by a switch lever or a mechanical timer) or electronically (for example, by an electronic timer or other electronic mechanism) and which switches the current flowing into electrical circuit either through overcurrent device 131 or overcurrent device 132.

In one embodiment, dual-mode breaker 200 is communicatively linked to one or more secure generation disconnects 107 (not shown for simplicity) via communications network 103. Additionally, one or more secure keys 115 are operable with dual-mode breaker 200 and where each secure key 115 is logically associated with a secure generation disconnect 107 (for example using a unique identifier). In one embodiment, switch 114 located on secure generation disconnect 107 is actuated when a secure key 115 is physically or electronically proximate of dual-mode breaker 200, and disconnected when secure key 115 is not physically or electronically proximate of dual-mode breaker 200. In this manner, any power generating devices 108 connected to secure generation disconnects 107 can only operate when a secure key 115 supplied by a secure key authority is physically or electronically proximate of dual-mode breaker 200, thus preventing unauthorized or disabled power generating devices 108 from supplying power to electrical circuit 111.

In a further embodiment, pressing synchronizing button 136 on dual-mode breaker 200 while simultaneously pressing a similar synchronizing button 125 on secure generation disconnect 107 enables the authorization of a secure key that can be used to enable secure generation disconnect 107 as described herein.

In one embodiment, to prevent runaway generation and potential overloading of electrical circuit 111, when switch 133 is set to position 211 and current is flowing into electrical circuit through overcurrent device 132, signal generator 134 produces one or more digital or analog signals of a predetermined frequency which may be used as a carrier wave for communications and is communicated to each secure generation disconnect 107 via communications network 103 and is required to be present by all secure generation disconnects 107 in order to have permission to generate power. Thus, when switch 133 is set to position 210 and current is flowing into electrical circuit through overcurrent device 131, signal generator 134 stops generating a permission-to-generate signal, any secure generation disconnects 107 synchronized to this signal immediately interrupt all power generation until switch 133 is set to position 211 and the permission-to-generate power signal has been restored.

FIG. 21 is a schematic of one embodiment of a dual-mode circuit breaker 201 that fits inside an existing electrical outlet located between a circuit breaker panel 101 a first electrical outlet 106 (as shown in FIG. 5) and includes an overcurrent device 132 that limits the current flowing into the electrical circuit 111 to the de-rated amount A_{D}, a switch 133 which may be either physical or electronic and can be actuated either manually (for example, by a switch lever or a mechanical timer) or electronically (for example, by an electronic timer or other electronic mechanism) and which switches the current flowing into electrical circuit either directly into electrical into electrical circuit 111 or through overcurrent device 132.

In one embodiment, dual-mode breaker 201 is communicatively linked to one or more secure generation disconnects 107 (not shown for simplicity) via communications network 103. Additionally, one or more secure keys 115 are operable with dual-mode breaker 201 and where each secure key 115 is logically associated with a secure generation disconnect 107 (for example using a unique identifier). In one embodiment, switch 114 located on secure generation disconnect 107 is actuated when a secure key 115 is physically or electronically proximate of dual-mode breaker 201, and disconnected when secure key 115 is not physically or electronically proximate of dual-mode breaker 201. In this manner, any power generating devices 108 connected to secure generation disconnects 107 can only operate when a secure key 115 supplied by a secure key authority is physically or electronically proximate of dual-mode breaker 201, thus preventing unauthorized or disabled power generating devices 108 from supplying power to electrical circuit 111.

In a further embodiment, pressing synchronizing button 136 on dual-mode breaker 201 while simultaneously pressing a similar synchronizing button 125 on secure generation disconnect 107 enables the authorization of a secure key that can be used to enable secure generation disconnect 107 as described herein.

In one embodiment, to prevent runaway generation and potential overloading of electrical circuit 111, when switch 133 is set to position 211 and current is flowing into electrical circuit through overcurrent device 132, signal generator 134 produces one or more digital or analog signals of a predetermined frequency which may be used as a carrier wave for communications and is communicated to each secure generation disconnect 107 via communications network 103 and is required to be present by all secure generation disconnects 107 in order to have permission to generate power. Thus, when switch 133 is set to position 210 and current is flowing directly into electrical circuit, signal generator 134 stops generating a permission-to-generate signal and any secure generation disconnects 107 synchronized to this signal immediately interrupt all power generation until switch 133 is set to position 211 and the permission-to-generate power signal has been restored.

### Miscellaneous

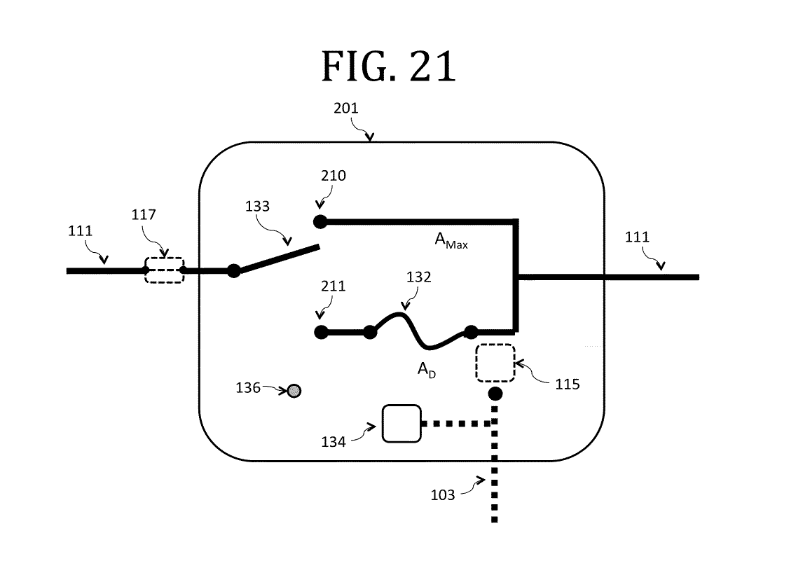

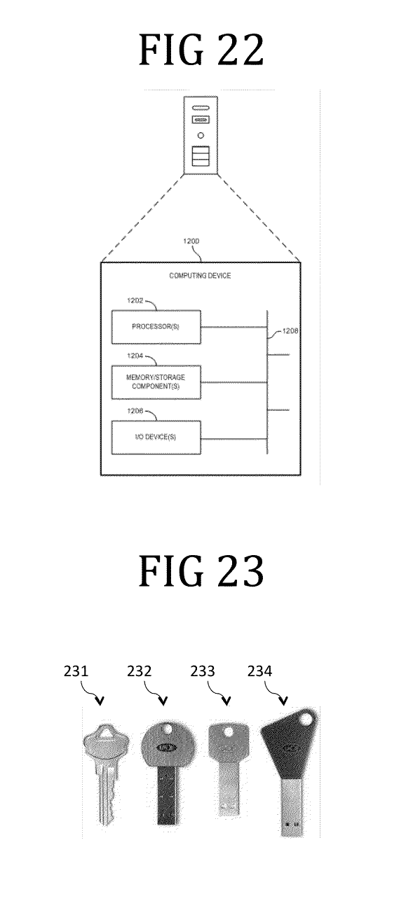

It will be appreciated by one of ordinary skill in the art that at least some of the embodiments described herein or parts thereof may be implemented using hardware, firmware and/or software. The firmware and software may be implemented using any suitable computing device(s). FIG. 22 shows an example of a computing device 1200 according to one embodiment that may be used for implementing processor-based de-rated breakers 105, secure generation disconnects 107, monitoring consoles 100 and management consoles 122. For the sake of clarity, the computing device 1200 is illustrated and described here in the context of a single computing device. However, it is to be appreciated and understood that any number of suitably configured computing devices 1200 can be used to implement any of the described embodiments. It also will be appreciated that one such device or multiple devices may be shared in a time division multiplex mode among compensators for multiple power amplifiers, as may be the case, for example, in a base station of a mobile communication network. For example, in at least some implementations, multiple communicatively linked computing devices 1200 are used. One or more of these devices may be communicatively linked in any suitable way such as via one or more networks. One or more networks can include, without limitation: the Internet, one or more local area networks (LANs), one or more wide area networks (WANs) or any combination thereof. Network communication may include, without limitation: wired technologies such as Ethernet, twisted pair, coaxial cable, optical fiber, power line communication (PLC) or wireless technologies such as Wi-Fi/IEEE 802.11x, Bluetooth, Zigbee, WiMAX, General Packet Radio Service (GPRS), EDGE, CDMA, GSM, Near Field Communication (NFC), Radio Frequency Identification (RFID), microwave, infrared or any combination thereof. Additionally, information may be transmitted as a single stream or multiplexed to combine multiple analog message signals or digital data streams into a single signal.

In this example, the computing device 1200 may comprise one or more processor circuits or processing units 1202, one or more memory circuits and/or storage circuit component(s) 1204 and one or more input/output (I/O) circuit devices 1206. Additionally, the computing device 1200 comprises a bus 1208 that allows the various circuit components and devices to communicate with one another. The bus 1208 represents one or more of any of several types of bus structures, including a memory bus or memory breaker, a peripheral bus, an accelerated graphics port, and a processor or local bus using any of a variety of bus architectures. The bus 1208 may comprise wired and/or wireless buses.

The processing unit 1202 may be responsible for executing various software programs such as system programs, applications programs, and/or program modules/blocks to provide computing and processing operations for the computing device 1200. The processing unit 1202 may be responsible for performing various voice and data communications operations for the computing device 1200 such as transmitting and receiving voice and data information over one or more wired or wireless communications channels. Although the processing unit 1202 of the computing device 1200 is shown in the context of a single processor architecture, it may be appreciated that the computing device 1200 may use any suitable processor architecture and/or any suitable number of processors in accordance with the described embodiments. In one embodiment, the processing unit 1202 may be implemented using a single integrated processor.

The processing unit 1202 may be implemented as a host central processing unit (CPU) using any suitable processor circuit or logic device (circuit), such as a as a general purpose processor. The processing unit 1202 also may be implemented as a chip multiprocessor (CMP), dedicated processor, embedded processor, media processor, input/output (I/O) processor, co-processor, microprocessor, breaker, microbreaker, application specific integrated circuit (ASIC), field programmable gate array (FPGA), programmable logic device (PLD), or other processing device in accordance with the described embodiments.

As shown, the processing unit 1202 may be coupled to the memory and/or storage component(s) 1204 through the bus 1208. The bus 1208 may comprise any suitable interface and/or bus architecture for allowing the processing unit 1202 to access the memory and/or storage component(s) 1204. Although the memory and/or storage component(s) 1204 may be shown as being separate from the processing unit 1202 for purposes of illustration, it is worthy to note that in various embodiments some portion or the entire memory and/or storage component(s) 1204 may be included on the same integrated circuit as the processing unit 1202. Alternatively, some portion or the entire memory and/or storage component(s) 1204 may be disposed on an integrated circuit or other medium (e.g., hard disk drive) external to the integrated circuit of the processing unit 1202. In various embodiments, the computing device 1200 may comprise an expansion slot to support a multimedia and/or memory card, for example.

The memory and/or storage component(s) 1204 represent one or more computer-readable media. The memory and/or storage component(s) 1204 may be implemented using any computer-readable media capable of storing data such as volatile or non-volatile memory, removable or non-removable memory, erasable or non-erasable memory, writeable or re-writeable memory, and so forth. The memory and/or storage component(s) 1204 may comprise volatile media (e.g., random access memory (RAM)) and/or nonvolatile media (e.g., read only memory (ROM), Flash memory, optical disks, magnetic disks and the like). The memory and/or storage component(s) 1204 may comprise fixed media (e.g., RAM, ROM, a fixed hard drive) as well as removable media (e.g., a Flash memory drive, a removable hard drive, an optical disk). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 1206 may allow a user to enter commands and information to the computing device 1200, and also may allow information to be presented to the user and/or other components or devices. Examples of input devices include data ports, ADCs, DACs, a keyboard, a cursor control device (e.g., a mouse), a microphone, a scanner and the like. Examples of output devices include data ports, ADCs, DACs, a display device (e.g., a monitor or projector, speakers, a printer, a network card). The computing device 1200 may comprise an alphanumeric keypad coupled to the processing unit 1202. The keypad may comprise, for example, a QWERTY key layout and an integrated number dial pad. The computing device 1200 may comprise a display coupled to the processing unit 1202. The display may comprise any suitable visual interface for displaying content to a user of the computing device 1200. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 1202 may be arranged to provide processing or computing resources to the computing device 1200. For example, the processing unit 1202 may be responsible for executing various software programs including system programs such as operating system (OS) and application programs. System programs generally may assist in the running of the computing device 1200 and may be directly responsible for controlling, integrating, and managing the individual hardware components of the computer system. The OS may be implemented, for example, as a Microsoft® Windows OS, Symbian OSTM, Embedix OS, Linux OS, Binary Run-time Environment for Wireless (BREW) OS, Java OS, or other suitable OS in accordance with the described embodiments. The computing device 1200 may comprise other system programs such as device drivers, programming tools, utility programs, software libraries, application programming interfaces (APIs), and so forth.

Various embodiments may be described herein in the general context of computer executable instructions, such as software or program modules/blocks, being executed by a computer. Generally, program modules/blocks include any software element arranged to perform particular operations or implement particular abstract data types. Software can include routines, programs, objects, components, data structures and the like that perform particular tasks or implement particular abstract data types. An implementation of these modules/blocks or components and techniques may be stored on some form of computer-readable media. In this regard, computer-readable media can be any available medium or media used to store information and accessible by a computing device. Some embodiments also may be practiced in distributed computing environments where operations are performed by one or more remote processing devices that are linked through a communications network. In a distributed computing environment, program modules/blocks may be located in both local and remote computer storage media including memory storage devices.

Although some embodiments may be illustrated and described as comprising functional component or modules/blocks performing various operations, it can be appreciated that such components or modules/blocks may be implemented by one or more hardware components, software components, and/or combination thereof. The functional components and/or modules/blocks may be implemented, for example, by logic (e.g., instructions, data, and/or code) to be executed by a logic device (e.g., processor). Such logic may be stored internally or externally to a logic device on one or more types of computer-readable storage media. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSPs), field programmable gate array (FPGA), logic gates, registers, semiconductor devices, chips, microchips, chip sets, and so forth. Examples of software may include software components, programs, applications, computer programs, application programs, system programs, machine programs, operating system software, middleware, firmware, software modules/blocks, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

It also is to be appreciated that the described embodiments illustrate example implementations, and that the functional components and/or modules/blocks may be implemented in various other ways which are consistent with the described embodiments. Furthermore, the operations performed by such components and/or modules/blocks may be combined and/or separated for a given implementation and may be performed by a greater number or fewer number of components and modules/blocks.

FIG. 23 is a schematic of several embodiments of physical keys 231, 232, 233 and 234 than may used to operate an electrical switch or actuator operable with a secure generation disconnect 107.

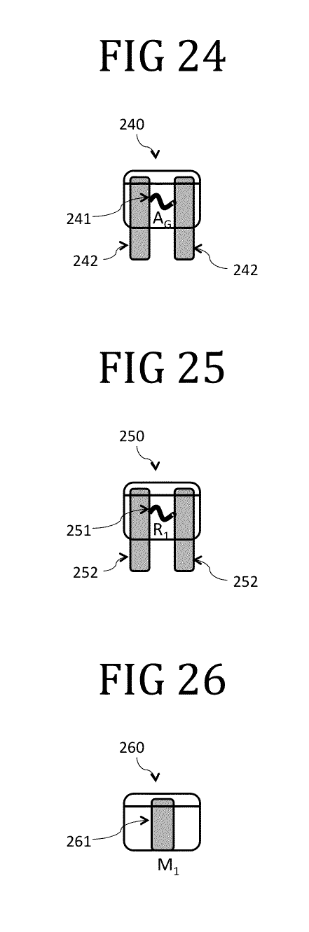

FIG. 24 is a schematic of a fusible key 240 that includes a fusible conductor 241 with a rating A_{G} and two connectors 242 and which may be inserted into a secure generation disconnect 107 to enable power generation.

FIG. 25 is a schematic of a resistive key 250 that includes a resistive conductor 251 with a rating R₁ and two connectors 252 and which may be inserted into a secure generation disconnect 107 to actuate switch 114 and enable power generation.

FIG. 26 is a schematic of an electro-magnetic secure key 260 that includes a magnetic element 261 with a magnetic flux M₁ and which may be inserted into a secure generation disconnect 107 to actuate switch 114 and enable power generation.

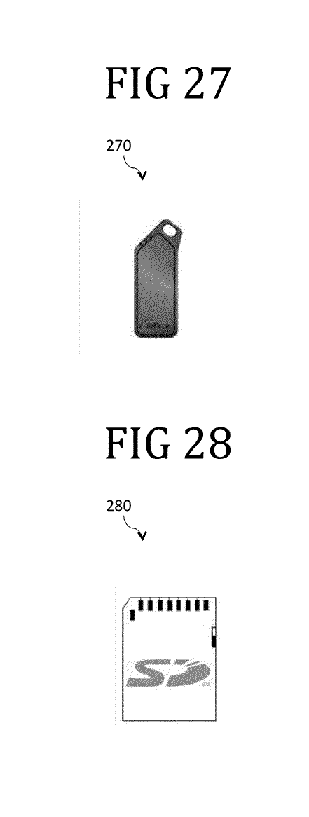

FIG. 27 is a illustration of an electronic proximity key 270 which may be inserted into or be made physically or electronically proximate with a secure generation disconnect 107 to actuate switch 114 and enable power generation.

FIG. 28 is a schematic of a digital storage device 280 containing a digital key and which may be inserted into a secure generation disconnect 107 to actuate switch 114 and enable power generation.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a generation breaker” should typically be interpreted to mean “at least one generation breaker”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two generation breakers,” or “a plurality of generator breakers,” without other modifiers, typically means at least two generator breakers). Furthermore, in those instances where a phrase such as “at least one of A, B, and C,”“at least one of A, B, or C,” or “an [item] selected from the group consisting of A, B, and C,” is used, in general such a construction is intended in the sense one having skill in the art would understand the convention (e.g., any of these phrases would include but not be limited to systems that have A alone, B alone, C alone, A and B together, A and C together, B and C together, and/or A, B, and C together). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting and it is therefore to be understood that the appended claims are intended to cover all such modifications and changes as fall within the scope of the embodiments.

1. A power bus comprising: an electrical circuit; a first de-rated circuit breaker on a first electrical circuit and which limits the total current flowing through the first electrical circuit and is rated less than current rating of the circuit; one or more secure generation disconnects connected to the first electrical circuit and to one or more associated power generating devices, and which limit the total current generated by one or more associated power generation devices to the rated capacity of the secure generation disconnect, and further which combined with the first de-rated breaker limit the total current flowing through the first electrical circuit at or below its rated capacity.

2. A method of operating a power bus including an electrical circuit, a first de-rated circuit breaker on a first electrical circuit and which limits the total current flowing through the first electrical circuit and is rated less than current rating of the circuit; one or more secure generation disconnects connected to the first electrical circuit and to one or more associated power generating devices, and which limit the total current generated by one or more associated power generation devices to the rated capacity of the secure generation disconnect, and further which combined with the first de-rated breaker limit the total current flowing through the first electrical circuit to it's rated capacity, the method comprising: associating one or more secure generation disconnects with a first de-rated circuit breaker and which when combined with the first de-rated breaker limit the total current flowing through the first electrical circuit at or below its rated capacity.

3. A power bus comprising: an electrical circuit; a first de-rated circuit breaker on a first electrical circuit and which limits the total current flowing through the first electrical circuit and is rated less than current rating of the circuit, and which is further communicatively linked to one or more secure generation disconnects connected to the first electrical circuit and to one or more associated power generating devices, and which limit the total current generated by one or more associated power generation devices to the rated capacity of the secure generation disconnect, and further which combined with the first de-rated breaker limit the total current flowing through the first electrical circuit at or below its rated capacity; and a secure key logically associated with each secure generation disconnect which activates the secure generation disconnect when a secure key is physically or electronically proximate of de-rated breaker and deactivates the secure generation disconnect when secure key is not physically or electronically proximate of de-rated breaker.

4. (canceled)
